(19) United States
(12) Patent Application Publication
(10) Pub. No.: US 2023/0018863 A1
(43) Pub. Date: Jan. 19, 2023

(54) JOB SEARCH SOFTWARE APPLICATION FOR INCARCERATED INDIVIDUALS

(71) Applicant: Yuvraj Valrani, Dubai (AE)

(72) Inventor: Yuvraj Valrani, Dubai (AE)

(21) Appl. No.: 17/944,115

(22) Filed: Sep. 13, 2022

(51) Int. Cl. G06Q 10/10

(52) U.S. Cl. CPC G06Q 10/1053

(57) ABSTRACT

One embodiment provides a method, the method including: providing a job search software application for incarcerated individuals, wherein the job search software application displays a graphical user interface for receiving input from a user and displaying visual output to the user; receiving a pool of jobs; categorizing each of the jobs within the pool of jobs into a job category, wherein each of the job categories identify requirements for the jobs contained with a job category; receiving a plurality of job-related input from a user, wherein the plurality of job-related input comprises input from the user related to job requirements; filtering the pool of jobs based upon the job-related input by correlating the job-related input to requirements of the job categories and removing jobs contained within a job category that do not satisfy the job-related input; and displaying the filtered pool of jobs. Other aspects are described and claimed.

### BACKGROUND

When searching for a job, there are many different resources that can be utilized. For example, a user may utilize a job search engine where employers can post jobs and job requirements. These job search engines generally also allow a user to apply for a posted job. As another example, a user may utilize a recruiter who is employed to find potential job positions for a user. Recruiters frequently have connections with companies or other employers, thereby giving a job candidate access to job positions that may not be available or known using other sources. As another example, a user may utilize a job services agency. At job service agencies a user typically talks to an employee of the agency, provides job requirements, and the employee can tell the user of jobs that may fit the requirements. Job service agencies may provide additional services, for example, testing facilities to test users for requirements that may be specific to certain jobs, for example, typing tests, lifting or physical tests, and/or other ability-based or aptitude-based tests.

### BRIEF SUMMARY

In summary, one aspect provides a method, the method including: providing a job search software application for incarcerated individuals, wherein the job search software application displays a graphical user interface for receiving input from a user and displaying visual output to the user; receiving, at the job search software application, a pool of jobs; categorizing, using the job search software application, each of the jobs within the pool of jobs into a job category, wherein each of the job categories identify requirements for the jobs contained with a job category; receiving, at the graphical user interface of the job search software application, a plurality of job-related input from a user, wherein the plurality of job-related input includes input from the user related to job requirements; filtering, using the job search software application, the pool of jobs based upon the job-related input by correlating the job-related input to requirements of the job categories and removing jobs contained within a job category that do not satisfy the job-related input; and displaying, within the graphical user interface of the job search software application, the filtered pool of jobs.

Another aspect provides an information handling device, the information handling device including: a processor; a memory device that stores instructions that, when executed by the processor, causes the information handling device to: provide a job search software application for incarcerated individuals, wherein the job search software application displays a graphical user interface for receiving input from a user and displaying visual output to the user; receive, at the job search software application, a pool of jobs; categorize, using the job search software application, each of the jobs within the pool of jobs into a job category, wherein each of the job categories identify requirements for the jobs contained with a job category; receive, at the graphical user interface of the job search software application, a plurality of job-related input from a user, wherein the plurality of job-related input includes input from the user related to job requirements; filter, using the job search software application, the pool of jobs based upon the job-related input by correlating the job-related input to requirements of the job categories and removing jobs contained within a job category that do not satisfy the job-related input; and display, on the graphical

A further aspect provides a product, the product including: a computer-readable storage device that stores executable code that, when executed by a processor, causes the product to: provide a job search software application for incarcerated individuals, wherein the job search software application displays a graphical user interface for receiving input from a user and displaying visual output to the user; receive, at the job search software application, a pool of jobs; categorize, using the job search software application, each of the jobs within the pool of jobs into a job category, wherein each of the job categories identify requirements for the jobs contained with a job category; receive, at the graphical user interface of the job search software application, a plurality of job-related input from a user, wherein the plurality of job-related input includes input from the user related to job requirements; filter, using the job search software application, the pool of jobs based upon the job-related input by correlating the job-related input to requirements of the job categories and removing jobs contained within a job category that do not satisfy the job-related input; and display, within the graphical user interface of the job search software application, the filtered pool of jobs.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for providing a job search software application that can filter a pool of jobs based upon input received from a user utilizing the job search software application.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

While most users or people have access to many different job finding resources, some part of the population is not so advantaged. One type of person who may have a difficult time finding a job and/or accessing job resources is a person who was incarcerated for a length of time. Some entities and/or companies may not hire formally incarcerated people. Additionally, even if there are entities that are willing to hire formally incarcerated people, these people may not know how to find such jobs, particularly if the person was incarcerated for a significant length of time. When released from a jail, prison, penitentiary, or other incarceration facility, the person generally is not given many if any resources for functioning back into society, including assistance finding a job. Without the ability to find a job and, therefore, maintain a steady source of income, many formally incarcerated people recidivate and end up back in an incarceration facility. While there are many job finding resources, none of them are focused on assisting formally incarcerated people in finding a job based upon any qualifications and/or requirements for the formally incarcerated individual. Additionally, many incarcerated individuals may not know of the job finding resources or have the ability to access these resources.

Accordingly, the described system and method provides a technique for providing a job search software application that can filter a pool of jobs based upon input received from a user utilizing the job search software application. The job search software application displays a graphical user interface that can receive input from a user and that displays visual output to the user. The software application receives a pool of jobs and categorizes each of the jobs within the pool of jobs. If a job cannot be categorized by the application, a user may be requested to manually categorize the job or the job may be dropped from the pool of jobs. Each of the job categories identifies requirements for the jobs contained within a job category. While certain jobs within a category may have different requirements, the job category requirements identify the minimum requirements for the jobs contained within the job category. In other words, the category requirements are requirements that would be applicable to most, if not all, jobs contained within the category.

An individual can access the graphical user interface of the job search software application and provide a plurality of job-related input. The job-related input is information from a user that can be related to a job requirement. For example, the job-related input may include salary requirements, qualifications of the individual, skills of the individual, job requirements, and/or the like. In addition to the job-related input, the user may provide other information, for example, identification information, resume information, or other information that is not directly related to a job requirement but that may be useful in the job search software application, particularly if an application for a job is provided within the software application. The filtering information may not only include the user filling out requests for information, but may also include the user providing input into different tests, for example, personality tests, typing tests, and/or other tests that may be useful in identifying suitable jobs for the individual. The job search software application facilitates the performance of the tests, for example, in the graphical user interface of the software application, and the output of the tests is accessible and may be utilized by the software application to filter the pool of jobs.

Using the job-related input, the job search software application filters the pool of jobs by correlating the job-related input to job category requirements and removing jobs contained within a job category that do not fulfill the requirements. In other words, the job search application can remove jobs that the individual does not qualify for, has provided an indication that the individual would not want to do, or that does not meet some requirement of the individual. The receipt of filtering information and job filtering may be an iterative process where the software application receives information and filters the pool of jobs based upon that information, receives the next piece of information and filters the previously filtered pool of jobs based upon this new information, and so on. On the other hand, the software application may wait to receive all the filtering information and then filter the pool of jobs once all the information is received. Once the pool of jobs has been filtered, the job search software application displays the filtered pool of jobs on the graphical user interface. The displaying of the filtered pool of jobs may occur after every filter, once a predetermined number of jobs has been reached, upon request by the individual, and/or the like.

The described system represents a technical improvement over current techniques for providing a job search software application. While some job search engines may allow a user to filter jobs based upon geographic location, salary requirements, and/or the like, these job search engines do not receive and analyze information from an individual to identify a job or job category that may be suitable for the individual. Additionally, unlike the described system, the job search engines do not integrate tests into the engine that would assist the system in identifying suitable jobs for the individual. In other words, job search engines simply take input provided by a user and filter based upon the specific input, meaning the individual has to know what they are looking for in a job, which may be difficult for some individuals. The job search engines do not provide additional analysis or request information that can be used for analysis that would assist in guiding the individuals to a job or job category. Thus, the described system is more sophisticated than a simply job search engine.

The illustrated example embodiments will be best understood by reference to the figures. The following description is intended only by way of example, and simply illustrates certain example embodiments.

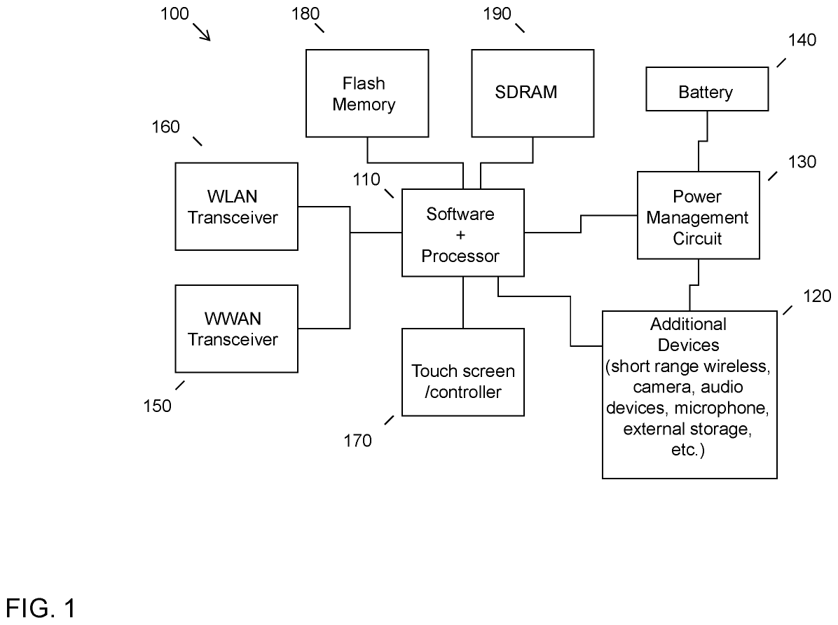

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

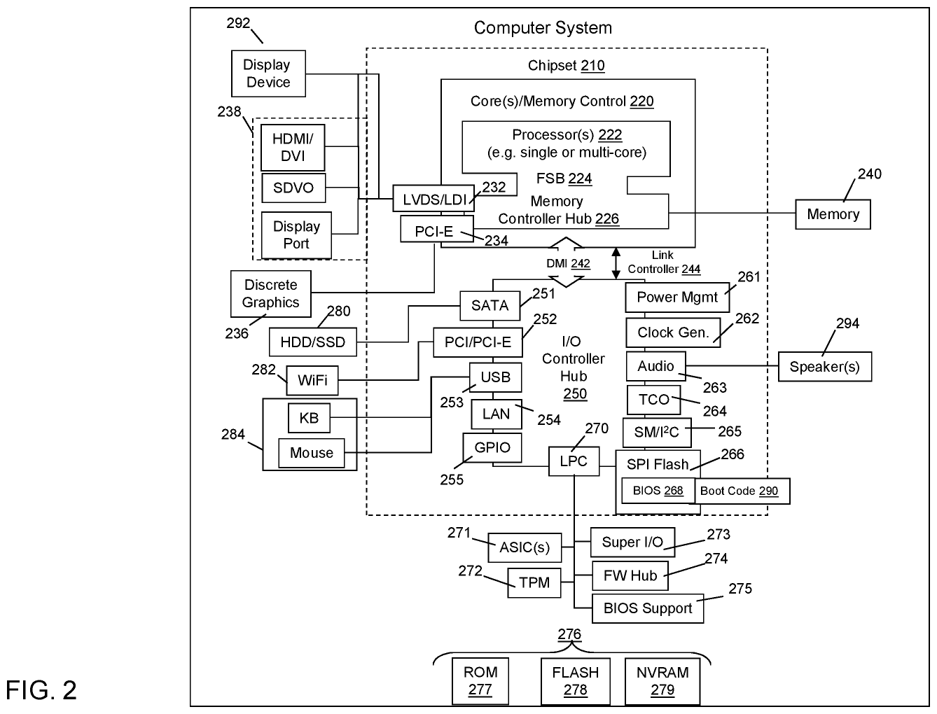

FIG. 2 depicts a block diagram of another example of information handling device circuits, circuitry or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be utilized in a job search system, for example, to perform the job filtering, receiving user input, displaying output based upon user input, and/or the like. For example, the circuitry outlined in FIG. 1 may be implemented in a tablet or smart phone embodiment, whereas the circuitry outlined in FIG. 2 may be implemented in a personal computer embodiment.

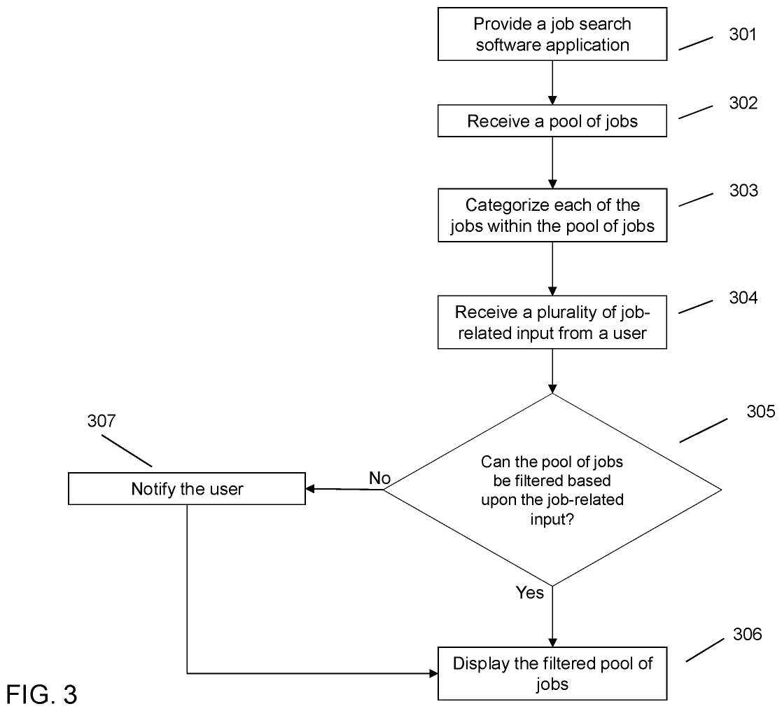

FIG. 3 illustrates an example method for providing a job search software application that can filter a pool of jobs based upon input received from a user utilizing the job search software application. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to filter a job pool based upon user input. Additionally, the job search system, hardware components, and system includes modules and features that are unique to the described system.

While this software application can be utilized by any individual for assistance in locating a job, the main focus is assisting incarcerated, recently incarcerated, or formally incarcerated individuals in finding a job. However, this focus should not be construed to narrow the scope of this disclosure to only a job search software application for incarcerated or formally incarcerated individuals. For example, the software application could be modified to assist disabled individuals or other subsets of the population that may have difficulty find jobs or may be modified to work for the general population.

The job search software application may be a stand-alone application or may run in conjunction with another application, for example, within an Internet browser. The job search software application has an associated graphical user interface that can be displayed on a display device, for example, monitor, information handling device (e.g., smart phone, tablet, personal digital assistant, smart watch, television, etc.) display, and/or the like. The graphical user interface provides an interface allowing the user to provide input to the job search software application. The software application processes the input and then outputs information onto the display that is responsive to the provided input. For example, the graphical user interface may include a form that an individual fills out with different information. Based upon this information, the software application identifies jobs that may be a good match for the individual. The graphical user interface may present information in different ways. For example, in providing the questions or requests for information from the individual, the graphical user interface may present a form to the user. The graphical user interface may also present a series of requests where when the individual provides information, new requests are displayed, thereby stepping the individual through the needed information. Additionally, using this format, the system can provide different requests for information based upon previous responses, thereby resulting in more relevant requests for information.

An individual can create a user profile that allows the individual to save information within the job search software application. For example, if the individual is only able to finish part of the requests for information, the individual could save the progress and resume at a later time by accessing the saved information in the user profile. Additionally, the user profile allows the user to save jobs that have been identified for the user. The user profile also allows a user to rerun the job filtering on a new pool of jobs. As is understood, job availability is fluid and everchanging. Thus, instead of having to completely refill out the requests for information, the user can log into the user profile and request the job filtering be rerun on a possible new pool of jobs, which may result in different job results for the user. An individual may also change answers to requests for information. For example, maybe a desired target industry, geographical area, or salary has changed. The user could access the user profile and change only those responses that are different, thereby preventing the user from having to completely restart the requests for information.

It should be noted that the use of a user profile is not strictly necessary and the individual may instead be a guest user, meaning the information will not be saved for later access. The user profile does not have to be strictly based upon a specific identity of an individual and may be genericized, for example, instead of a name, the user could have a random user name, assigned number identifier, and/or the like. Additionally, the user may prefer to restart the requests for information from the beginning and would have the option to do so. The user may also stop providing answers to the requests for information at any point and have the ability to request the jobs that match or fulfill the requirements of the individual that have been identified up to the point the individual provides the request for the jobs.

At 301 the job search software application is provided. As noted previously, the job search software application displays a graphical user interface that allows for receiving input from a user and displaying visual output to the user. The layout of the graphical user interface may vary and may include icons, input fields, graphics, output areas, and/or the like. Input fields may be free-form unstructured input areas, structured input areas, radial selection buttons, drop-down menus, and/or the like. The input fields and corresponding text will be referred to as requests for information.

At 302 the job search software application receives a pool of jobs. To create or receive the pool of jobs, the job search software application may scrape websites that have job listings, for example, job search engines, job aggregation websites, employment web sites, company or entity websites, job agency websites, and/or the like. The job search application may also scrape information from secondary sources, for example, digital newspapers, digital advertisements, social media postings, and/or the like. The job search application may employ language analysis techniques to understand the information and context contained within a job listing so that the job listing can be further analyzed for job requirements. A non-exhaustive list of example language analysis techniques includes information extractors, semantic analysis, syntactic analysis, parts-of-speech analyzers, a combination thereof, and/or the like. The language analysis techniques allow the job search application to parse and recognize different entities within the job listing in order to understand the information and context contained within the job listing.

A user or group of users may manually upload job listings to the job search software application. For example, an entity or company facilitating, sponsoring, or providing the job search software application may come to know of job listings and may thereafter upload, manually enter, or otherwise add or provide the job listing to the job search application. The user may also upload job listings from non-digital sources, for example, newspapers, magazines, advertisements, and/or the like. The user may scan the job listing into the system, take a picture of the job listing, manually enter the information of the job listing, and/or the like. In the case that a scan or picture is taken, the job search application may employ one or more techniques to recognize the information contained in the image so that the job search application can further utilize the information corresponding to the job listing. For example, the job search application may employ optical character recognition techniques to recognize text or characters within an image and language analysis techniques, as briefly identified previously, and/or the like. The job search application may also receive job listings using a combination of techniques.

The job search application analyzes the job postings included in the pool of jobs to identify different information about the job posting. The information may be used to identify whether the job meets a first set of filter criteria. To perform this filtering, the job search application may compare information identified in the job listing to a database, keyword listing, and/or the like, that contains keywords, phrases, and/or the like, and rules associated with those keywords, phrases, and/or the like. Based upon a match between the information and the data store, the job search application will carry out the corresponding rule, which may include removing, redacting, emphasizing, and/or the like, with respect to the job listing.

The first set of filtering may be performed before any user or individual input is received. As previously mentioned, the job search application may be directed to a specific group of individuals such as incarcerated, recently incarcerated, or formerly incarcerated individuals. Some entities may be unwilling or unable to hire incarcerated or formerly incarcerated individuals. Thus, any job listings associated with those companies may be removed from the pool of jobs. As another example, certain departments within companies or entities may be prevented from hiring such individuals. Thus, any job listings associated with those departments may be removed from the pool of jobs. In these examples, the pool of jobs would then be a pool of jobs filtered to jobs available for formerly incarcerated individuals. The term “formerly incarcerated” will be used here throughout for ease of readability. However, this term is intended to encompass any stage of incarcerated individual, for example, currently incarcerated, recently incarcerated, soon-to-be formerly incarcerated, long ago incarcerated, and/or the like.

Some of the information may be analyzed to categorize the job within the pool of jobs at 303. The job categories may be defined by a provider of the job search application, within a secondary information source (e.g., government defined job categories, widely accepted defined job category documents, etc.), a combination thereof, and/or the like. The job categories may generally define a job field or job type. Non-limiting example job categories may include construction, agriculture, food industry, legal, finance, education, and/or the like. However, the job categories may be as refined or as general as desired, or each category may have sub-categories. For example, a finance category may be broken into accountant, tax preparer, bookkeeper, payroll, and/or the like. As another example, the food industry category may be broken into waitstaff, back-of-the house staff, fast food staff, hosting staff, and/or the like.

To categorize a job within the job category, the job search application system may employ a neural network, machine-learning model, and/or other learning algorithm. While there are differences between these types of learning algorithms, the term “machine-learning model” will be used generally herein to refer to any of these types of learning algorithms and is not intended to limit the scope of this disclosure to only a machine-learning model. The machine-learning model can be trained utilizing a training dataset. The training dataset includes job listings that have been labeled or annotated with a job category or sub-category. The model ingests the training dataset and, once trained, can make predictions for job category or sub-category labels for new unlabeled job listings. As predictions are made and feedback is received regarding the accuracy of the labeling by the model, the model can ingest the feedback to become more accurate and refined over time. The feedback may include a user manually changing a job listing to a different category or sub-category, a job listing being re-categorized at a later time, and/or the like. The model can automatically ingest the feedback without a user having to provide the feedback directly to the model.

Each of the job categories and/or sub-categories may have different job requirements. Thus, each of the job categories may identify requirements for jobs contained within that category. Non-limiting examples of job requirements include a particular education level, the ability to drive a vehicle, the ability to lift a certain amount of weight over a certain distance, typing speed, the ability to relocate, certain skills, particular certifications, the ability to pass a background check, and/or the like. Additionally, since some job categories may not be available to individuals who have been convicted of a particular type of crime, if the job search application is defined for formerly incarcerated individuals, the job category requirements may include not having convictions for a particular type of crime. For example, an individual convicted of certain financial crimes may be unable to work in some finance jobs. Job category requirements may be defined by a provider of the application, within a secondary information source, mined from the job listings included within a category, a combination thereof, and/or the like.

To mine the job requirements from job listings, the job search application may utilize one or more language analysis techniques, such as those previously discussed, to identify different entities included in the job listing. Once the entities are identified, using one or more language analysis techniques, the job search application can assign a type or label to the entities. Using this information, the job search application can identify the information included in a job listing that corresponds to a job requirement. This information can be extracted from the job listings within the job category to define job category requirements. Identification of job requirements may also be performed using a machine-learning model that has been trained to make predictions regarding whether information contained within a job listing should be identified or labeled as job requirements.

Job category requirements, either category or sub-category requirements, are intended to be those job requirements which apply to the majority of the job listings included within a job category. Thus, while a job requirement may be extracted from a job listing, that requirement may not also be defined as a job category requirement. This occurs because different job listings within a job category can and will likely have different requirements. However, there are likely similar requirements among the job listings within a job category or job sub-category, and these similar requirements can be defined as job category requirements. It should be noted that not all the jobs within a job category or sub-category have to have the same requirement for the requirement to be defined as a job category requirement. Rather, the application system may define requirements as job category requirements if a particular percentage of the job listings have the requirement.

An individual may access the job search software application via the graphical user interface and may provide job-related input. Thus, the job search software application may receive a plurality of job-related input from a user at 304. In other words, an individual may access the job search software application and respond to the requests for information contained within the graphical user interface. The requests for information may include identifying information, for example, name, address, telephone number, and/or other identifying information. The requests for information may also include information related to job requirements of the individual, for example, preferred geographical location, salary requirements, and/or the like. Additionally, the requests for information may include job qualification information, for example, education level, certifications, skills, previous work experience, and/or the like. The requests for information may include job preference information, for example, a type or category of job the individual prefers, a preferred working environment (e.g., outdoors, warehouse setting, travelling, desk work, sitting, etc.), and/or the like. Any responses to these requests for information are considered job-related input. Thus, job-related input may include job requirement input, identifying information input, job qualification input, job preference input, aptitude or ability information input, and/or the like.

The requests for information may also include aptitude or ability information. This information may include personality type, typing speed, physical abilities, and/or the like. Since the individual may not know some of this information, the job search software application can facilitate the performance of one or more tests to identify this information. For example, the graphical user interface may present a personality test, typing test, instructions for a physical ability test, and/or the like. As the individual provides input to the tests, the results of the test will be available to the job search software application. Thus, the results of the test may be used as job-related input by the job search application.

As should be understood, not only does the job-related input include typical job search information (e.g., salary, location, etc.), but also includes information that the job search application can utilize to identify a job type or specific job that may be suitable to the individual. In other words, the job search application requests information from the individual that can assist in identifying the types of jobs that an individual may like or excel at based upon the aptitude, skills, and other job-related information provided by the individual. In order to make this identification, the job search application may analyze the job-related input by correlating the input to at least one job type and utilize the job type as a job requirement. In other words, based upon the job-related input provided by the individual, the system can correlate the job-related input to particular job fields or categories, referred to as a job type. For example, if an individual provides job-related input indicating the individual does not have a high school diploma, prefers to work indoors, and likes to interact with people, the job search application can correlate these to one or more job categories or sub-categories such as, for this example, food industry worker or retail worker.

Upon receipt of the job-related input, the job search software application determines if the pool of jobs can be filtered based upon the job-related input at 305. As previously noted, the pool of jobs may be a previously filtered pool of jobs, where the previous filtering occurred before receipt of any job-related input. The performance of this filtering may occur in a similar fashion as described with respect to the first filtering. The filtering may include comparing the job-related input to the job category requirements, requirements of a specific job, and/or the like. Since job-related input may not be provided exactly as a job category requirement, specific job requirement, or other type of requirement, the job search application may convert the job-related input to a format that matches the job category requirement, specific job requirement, or other type of requirement.

Additionally, not all job-related input may be directly related to a job requirement. Thus, the job search application may analyze the job-related input and correlate it to a job requirement or information included in a job category, sub-category, or listing. The correlation may occur utilizing a machine-learning model trained on using a training dataset including job-related annotated with job requirements. The correlation may also occur utilizing a database or other data store, secondary information source (e.g., Internet sources, job sources, etc.), and/or the like, that identifies correlations between job-related input and job requirements or identifies job information for job categories, sub-categories, or listings, that could be correlated to the job-related input. For example, a secondary source may indicate that a particular job category or sub-category is associated with jobs that are generally indoors, even though this information may not be directly included in a job listing.

It should be noted that the receipt of job-related input and the filtering may be an iterative process. In other words, instead of requiring the individual to complete the entirety of the requests for information, the job search application may filter the pool of jobs after each job-related input is received, after a certain number of job-related input is received, upon request by the user, after a certain length of time, after certain job-related input is completed (e.g., a section of the requests for information, after a milestone of the requests for information, upon encountering software programming indicators, etc.), and/or the like.

If the pool of jobs can be filtered at 305, the pool of jobs may be filtered by removing jobs or job categories, and therefore any jobs corresponding to the job category, that do not satisfy the job-related input from the pool of jobs. If the pool of jobs cannot be filtered, meaning the pool of jobs is not decreased, the job search application may notify the user at 307. There may be situations where job-related input does not result in a filtering of the pool of jobs. For example, as the pool of jobs gets smaller, some job-related input may no longer result in the filtering of the pool of jobs. As another example, some job-related input may be closely related to other job-related input and may, therefore, not result in a further reduction of the pool of jobs. Accordingly, the user may only be notified upon one or more conditions being met. For example, the user may be notified if a certain number of sequential job-related input has not resulted in filtering of the job pool, if a particular number of jobs within the job pool has been reached, if the job pool no longer includes any jobs, and/or the like.

If the filtering is successful at 305 and/or the user has been notified that the pool of jobs was not filtered at 307, the job search application may display the filtered pool of jobs within the graphical user interface at 308. The display of the filtered pool of jobs may be within a pop-up window of the graphical user interface, overlaying a graphic of the filtered pool of jobs on the graphical user interface, accessing a separate window or tab of the graphical user interface including the filtered jobs, and/or the like. As previously noted, display of the filtered pool of jobs may occur at one or more of a predetermined point, for example, once the pool of jobs reaches a particular number, upon request by a user, after particular milestones have been met, and/or the like. The displayed filtered pool of jobs may include the job categories, sub-categories, or specific job listings.

The job search software application may also facilitate the individual applying for a particular job. For example, the job search software application may provide a job application for a specific job, may fill in a job application based upon information received by the individual during the completion of the requests for information, may provide contact information corresponding to a hiring manager or hiring group for a particular job, and/or the like. The job search software application may also allow the individual to print out the job listings, send the job listings to another device (e.g., a mobile device, a laptop computer, a smart watch, etc.), and/or the like.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
providing a job search software application, wherein the job search software application displays a graphical user interface for receiving input from a user and displaying visual output to the user;
receiving, at the job search software application, a pool of jobs;
categorizing, using the job search software application, each of the jobs within the pool of jobs into a job category, wherein each of the job categories identify requirements for the jobs contained with a job category;
receiving, at the graphical user interface of the job search software application, a plurality of job-related input from a user, wherein the plurality of job-related input comprises input from the user related to job requirements;
filtering, using the job search software application, the pool of jobs based upon the job-related input by correlating the job-related input to requirements of the job categories and removing jobs contained within a job category that do not satisfy the job-related input; and
displaying, within the graphical user interface of the job search software application, the filtered pool of jobs.

2. The method of claim 1, wherein the job search application comprises a job search application directed to identifying jobs for formerly incarcerated individuals.

3. The method of claim 2, wherein the pool of jobs comprises a pool of jobs filtered to jobs available for formerly incarcerated individuals.

4. The method of claim 1, wherein the categorizing comprises utilizing a machine-learning model trained using a training dataset comprising annotated job listings.

5. The method of claim 1, wherein the filtering occurs after each of the plurality of job-related input is provided by the user.

6. The method of claim 1, wherein the receiving job-related input is responsive to displaying at least one request for information on the graphical user interface of the job search software application.

7. The method of claim 1, wherein the job-related input comprises a result of at least one test taken by the user and facilitated by the job search software application.

8. The method of claim 1, wherein the displaying is responsive to receiving user input indicating the filtered pool of jobs is to be displayed.

9. The method of claim 1, comprising analyzing the job-related input by correlating the job-related input to at least one job type and utilizing the job type as a job requirement.

10. The method of claim 1, wherein the job-related input comprises job requirements.

11. An information handling device, the information handling device comprising:
a processor;
a memory device that stores instructions that, when executed by the processor, causes the information handling device to:
provide a job search software application, wherein the job search software application displays a graphical user interface for receiving input from a user and displaying visual output to the user;
receive, at the job search software application, a pool of jobs;
categorize, using the job search software application, each of the jobs within the pool of jobs into a job category, wherein each of the job categories identify requirements for the jobs contained with a job category;
receive, at the graphical user interface of the job search software application, a plurality of job-related input from a user, wherein the plurality of job-related input comprises input from the user related to job requirements;
filter, using the job search software application, the pool of jobs based upon the job-related input by correlating the job-related input to requirements of the job categories and removing jobs contained within a job category that do not satisfy the job-related input; and
display, within the graphical user interface of the job search software application, the filtered pool of jobs.

12. The information handling device of claim 11, wherein the job search application comprises a job search application directed to identifying jobs for formerly incarcerated individuals.

13. The information handling device of claim 12, wherein the pool of jobs comprises a pool of jobs filtered to jobs available for formerly incarcerated individuals.

14. The information handling device of claim 11, wherein the categorizing comprises utilizing a machine-learning model trained using a training dataset comprising annotated job listings.

15. The information handling device of claim 11, wherein the filtering occurs after each of the plurality of job-related input is provided by the user.

16. The information handling device of claim 11, wherein the receiving job-related input is responsive to displaying at least one request for information on the graphical user interface of the job search software application.

17. The information handling device of claim 11, wherein the job-related input comprises a result of at least one test taken by the user and facilitated by the job search software application.

18. The information handling device of claim 11, wherein the displaying is responsive to receiving user input indicating the filtered pool of jobs is to be displayed.

19. The information handling device of claim 11, comprising analyzing the job-related input by correlating the job-related input to at least one job type and utilizing the job type as a job requirement.

20. A product, the product comprising:
a computer-readable storage device that stores executable code that, when executed by a processor, causes the product to:
provide a job search software application, wherein the job search software application displays a graphical user interface for receiving input from a user and displaying visual output to the user;
receive, at the job search software application, a pool of jobs;
categorize, using the job search software application, each of the jobs within the pool of jobs into a job category, wherein each of the job categories identify requirements for the jobs contained with a job category;
receive, at the graphical user interface of the job search software application, a plurality of job-related input from a user, wherein the plurality of job-related input comprises input from the user related to job requirements;
filter, using the job search software application, the pool of jobs based upon the job-related input by correlating the job-related input to requirements of the job categories and removing jobs contained within a job category that do not satisfy the job-related input; and
display, within the graphical user interface of the job search software application, the filtered pool of jobs.
